(19) United States
(12) Patent Application Publication
(10) Pub. No.: US 2021/0337999 A1
(43) Pub. Date: Nov. 4, 2021

(54) USER INTERFACE FOR OPERATION OF A LIQUID HEATING APPARATUS

(71) Applicant: Strix Limited, Ronaldsway, Isle of Man (GB)

(72) Inventor: Paul Mander, Goldstone Shropshire (GB)

(21) Appl. No.: 17/284,224

(22) PCT Filed: Oct. 9, 2019
(86) PCT No.: PCT/GB2019/052862

§ 371 Date: Apr. 9, 2021

(30) Foreign Application Priority Data
Oct. 9, 2018 (GB) 1816453.3

(51) Int. Cl. A47J 27/21; H05B 1/02

(52) U.S. Cl. CPC A47J 27/21083; A47J 27/2105; A47J 2202/00; A47J 27/21091; H05B 1/0269; A47J 27/21166

(57) ABSTRACT

A domestic liquid heating apparatus includes a liquid heating chamber and an electrical heating arrangement arranged to heat, in use, a liquid contained in the liquid heating chamber. The apparatus further includes a handle, for lifting the apparatus, and a user interface, arranged on the handle. The user interface comprises a rotatable dial, operable to select at least one operational parameter of the apparatus, and a display, arranged to display the selected operational parameter.

This application is entitled to the benefit of, and incorporates by reference essential subject matter disclosed in PCT Application No. PCT/GB2019/052862 filed on Oct. 9, 2019, which claims priority to GB Patent Appln. No. 1816453.3 filed Oct. 9, 2018, which are hereby incorporated by reference in their entireties.

### BACKGROUND OF THE INVENTION

### 1. Technical Field

The present invention is directed towards a user interface for operation of a liquid heating apparatus, particularly a kettle.

### 1. Background Information

In recent years, more sophisticated control over the way in which a liquid heating apparatus, e.g., a kettle, operates has become increasingly desirable. For example, users often want to be able to adjust the temperature to which the liquid within the apparatus is heated such that the heated liquid is at a desired temperature e.g., for a drink they are preparing. In order to provide this functionality, cordless kettles are known to be provided with a user interface arranged on the power base which is capable of selecting a temperature to which the contents of the kettle are heated. Such a user interface arranged on a power base is described in the Applicant's earlier application WO 01/28294. This particular arrangement does not provide a convenient means for operation, as once a user has set the cordless kettle down on the power base, they then have to separately operate the user interface arranged on the power base in order to operate the kettle.

Furthermore, arranging the user interface on a separate power base requires communication between the cordless kettle and the base in order to control the kettle in the desired manner. This increases the complexity and associated cost of the apparatus.

### SUMMARY OF THE INVENTION

The present invention aims to at least solve or at least mitigate the problems outlined above and when viewed from a first aspect provides a domestic liquid heating apparatus, comprising: a liquid heating chamber and an electrical heating arrangement arranged to heat, in use, a liquid contained in the liquid heating chamber; a handle, for lifting the apparatus; and a user interface, arranged on the handle, comprising: a rotatable dial operable to select at least one operational parameter of the apparatus; and a display arranged to display the at least one operational parameter selected by operation of the rotatable dial.

The Applicant has recognized that arranging the user interface on the handle of the liquid heating apparatus is advantageous as it may allow a user to more easily control operation of the liquid heating apparatus. As will be appreciated, the liquid heating apparatus may regularly need to be refilled. In order to refill the apparatus, a user may lift the liquid heating apparatus, by gripping the handle, and carry the apparatus, e.g., to a tap, for refilling. Once the apparatus has been filled, a user may then carry the apparatus back to a power point. This may be in the form of a power base for a cordless liquid heating apparatus, or a power cord in the case of a corded apparatus. The apparatus may be placed, either on the power base or another surface, with the user gripping the handle. Once the apparatus has been placed down, a user, still with their hand on the handle, may easily change the at least one operational parameter of the apparatus though operation of the rotatable dial. A user no longer has to release their grip on the apparatus and then operate a user interface on a different part of the apparatus. Accordingly, arranging the user interface on the handle of the apparatus may decrease the time it takes to select an operational parameter on the apparatus and also improve the general ease of use of the apparatus.

Arranging the user interface on the handle of the apparatus may also simplify the apparatus, particularly when the apparatus comprises a cordless vessel, as described in more detail below, as there is no longer necessarily any need for control communication between the cordless vessel and a power base. As will be appreciated, the user interface may be arranged within the apparatus to communicate directly with the relevant components, e.g., the electrical heating arrangement. Accordingly, simplification by providing the user interface in the handle may reduce the cost of the apparatus as means to communicate between the cordless vessel and power base may no longer be required.

Additionally, the provision of a rotatable dial may be beneficial as it may allow a user to easily select an operational parameter from one of a large number of operational parameters. For example, the rotatable dial may be arranged to select the temperature to which the liquid contained in the liquid heating chamber is heated. There may be a large number of potential selectable temperature options, for example up to 50 different temperature values, and thus the provision of a rotatable dial may allow a user to quickly navigate through the various selectable parameters and select their desired operational parameter.

The at least one operational parameter may be any one of a number of parameters relevant for controlling the operation of a liquid heating apparatus. However, in a preferred set of embodiments the at least one operational parameter corresponds to a final temperature to which the electrical heating arrangement is arranged to heat the liquid contained in the liquid heating chamber. The Applicant has recognized that the ability to control the temperature to which the contents of the liquid heating apparatus are heated to is perhaps the most common and/or desirable parameter which a user may wish to select, as often users want to adjust the temperature to which they heat the liquid e.g., depending on preference or a particular type of beverage they wish to make. Accordingly, by providing an easy to use and conveniently located user interface, a user may more easily select the final temperature to which the contents of the apparatus are heated.

Once the at least one operational parameter has been selected by a user operating the rotatable dial, the apparatus may then begin to heat the contents of the liquid heating chamber. For example, following the selection of a desired final temperature using the rotatable dial, the apparatus may instantaneously begin heating the contents of the liquid heating chamber to the desired temperature. Alternatively, following selection, the apparatus may pause for a short period of time, e.g., for 5 seconds, to allow a user to change their mind and further adjust the parameter, before beginning to heat the liquid within the liquid heating chamber. This automatic (instantaneous or delayed) start may be achieved through any suitable means, e.g., through the provision of a processor or analog circuitry.

However, the Applicant has recognized that it may be desirable for a user to be able to separately initiate execution of a selected operational parameter and/or control further operational parameters. Therefore, in a set of embodiments, the user interface further comprises an input means operable to implement the operational parameter selected by operation of the rotatable dial. As will be appreciated, in some examples, implementing the selected operational parameter may correspond to the apparatus being turned ON and/or OFF. In some embodiments, the input means may function to implement the selected operational parameter by controlling electrical power supplied to the heating arrangement. In some preferred embodiments, the input means is operable to implement the selected operational parameter by switching on the electrical heating arrangement. For example, the electrical heating arrangement may be switched on so as to heat a liquid contained in the heating chamber to a final temperature as selected by turning the rotatable dial.

In a set of potentially overlapping embodiments, the input means may be operable to select or control at least one further operational parameter in addition or alternatively to implementing the selected operational parameter. For example, operation of the input means may function to change different operational parameters such as a heating program the apparatus operates under. Accordingly, in a set of embodiments, the input means is operable to select at least one further operational parameter. In at least some examples the at least one further operational parameter corresponds to a pre-set mode of operation. In addition, or alternatively to selecting the at least one further operational parameter, the input means may be operable to change the at least one operational parameter which the rotatable dial is arranged to select. In other words, operation of the input means may function to change the rotatable dial from selecting, for example temperature, to instead selecting a heating mode or a heating time. In a set of embodiments, the at least one further operational parameter selected by the input means is also displayed on the display.

In one or more potentially overlapping embodiments, the input means comprises a further display, e.g., in the form of a display screen or at least one indicator light. The further display may indicate when the input means has been operated, e.g., an indicator light that is illuminated when the apparatus is turned ON. In at least some embodiments, the further display may indicate that the electrical heating arrangement has been switched on. In embodiments wherein the input means comprises a further display in the form of at least one indicator light, the at least one indicator light may function to illuminate the input means itself. The further display may also indicate when the selected operational parameter has been reached or completed. For example, the further display may comprise an indicator light that is extinguished when a liquid contained in the heating chamber has been heated to a final temperature as selected by turning the rotatable dial.

The input means may be provided by any suitable component which is capable of being operated by a user. For example, the input means may be provided by a switch which the user can operate, e.g., to turn the apparatus ON/OFF, or a further rotatable dial. However, in a preferred set of embodiments, the input means comprises a push button. As will be appreciated by those skilled in the art, the push button may be operated in a variety of different ways to implement the selected operational parameter and/or select at least one further operational parameter. In a set of embodiments, the push button is arranged to implement the selected operational parameter and/or select at least one further operational parameter based on the number of pushes of the push button. In an additional, or alternative set of embodiments, the push button is arranged to implement the selected operational parameter and/or select at least one further operational parameter based on the time for which the push button is depressed by a user. For example, a user may quickly press the push button to switch between different modes of operation, e.g., normal boil or rolling boil, and may press and hold the push button for an extended period of time in order to switch the apparatus ON.

In embodiments comprising an input means in addition to the rotatable dial, the rotatable dial and input means may be arranged in any suitable manner such that they can each be operated to provide their function. In a set of embodiments, the rotatable dial and input means are provided by separate, independently operable components. In other words, the rotatable dial is arranged to rotate relative to the input means.

In at least some embodiments, the user interface may be arranged on the handle such that the rotatable dial is physically separated from the input means. This can prevent a user from accidentally actuating the input means when adjusting the dial. However, it is often convenient for a user to be able to operate both the rotatable dial and input means as part of the same manual operation, e.g., using a thumb while gripping the handle. In at least some embodiments, the rotatable dial and input means are co-located in the user interface.

In a further set of embodiments the rotatable dial is arranged to surround the input means and is arranged to rotate independently around the input means. In a yet further set of embodiments the input means is arranged to be actuated along an axis of rotation of the rotatable dial. The arrangement of a rotatable dial which surrounds the input means in the manner described above may be advantageous as it may provide a component which can easily be operated by a user, e.g., by a user's thumb.

In an alternative set of embodiments to those described above, the rotatable dial and input means (e.g., push button) are provided by an integrated component arranged to rotate to control the at least one operational parameter and depress/push to implement the selected operational parameter and/or select at least one further operational parameter. The integrated component may, for example, be provided by a knob which can both rotate and be depressed along its axis of rotation. Thus, the dial itself may also act as a push button. Such an integrated component has the same advantages as the embodiments described above, specifically that it may be easy for a user to operate, particularly with a thumb.

The display need not necessarily be an electronic display. As will be appreciated by those skilled in the art, the display may be provided by a scale located proximal to the rotatable dial. In this case, the rotatable dial may be provided with an indicator that is directed towards the scale. A user may rotate the rotatable dial until the indicator provided thereon aligns with a desired marking on the scale which corresponds to their desired operational parameter, e.g., a specific temperature. However, in a preferred set of embodiments the display comprises an electronic display means. The electronic display means may be provided by any suitable means for outputting information, e.g., in the form of a series of light emitting means, e.g., LEDs, and/or an LCD or LED display. The electronic display means may comprise an electronic display screen. As will be appreciated, an electronic display means may be advantageous as it may allow for more sophisticated information to be presented to a user. For example, a specific temperature setting accurate to 1° C., which may not be possible with a non-electronic marked scale. It will be appreciated that an electronic display means is a display that is controlled electronically, i.e., by a microprocessor-based control.

The display may only be used to display the at least one operational parameter selected by a user and, in embodiments where an input means is also provided, the at least one further operational parameter. However, the Applicant has recognized that the display may be utilized to provide additional information to a user. Accordingly, in a set of embodiments, the display is further arranged to display additional information. For example, the display may output information relating to the current temperature of the liquid within the liquid heating chamber whilst it is being heated. In addition, or alternatively, the display may output the progress of the heating operation, e.g., as a percentage. Additional information, such as the examples given above, may be useful for a user in monitoring the status of the liquid heating apparatus.

The components of the user interface may be separated on the handle, for example the display may be located on a top portion of the handle and the rotatable dial, along with an input means where provided, may be located elsewhere, for example on a bottom portion of the handle. However, in a preferred set of embodiments the rotatable dial and display are substantially co-located in the user interface on the handle. Further, where an input means is provided, preferably the input means is also substantially co-located with the rotatable dial and display in the user interface. Co-locating the components of the user interface in this manner may help to reduce the complexity of the apparatus in that it may require less electrical wiring to be traced through the handle, and further it may mean that the user interface is easier and more intuitive to use.

The user interface may be arranged on any portion of the handle. However, as will be appreciated, preferably the user interface is located such that it can easily be operated by a user whilst gripping the handle. Accordingly, in a set of embodiments, the user interface is arranged on an upper portion of the handle. Arranging the user interface on an upper portion of the handle may mean that the user interface, in particular the display, is not gripped when a user grips the handle. This may help to ensure that a user can see the display and also ensure that a user can easily operate the rotatable dial (and input means, where provided).

The handle may take any suitable form that allows a user to easily, and comfortably, lift the liquid heating apparatus. However, in set of embodiments the handle comprises at least a first portion extending substantially horizontally away from the apparatus, and a second portion, extending from the first portion in a substantially vertical direction towards a base of the apparatus. As will be appreciated by those skilled in the art, the first and second portions effectively form an inverted ‘L’ shape, the second portion of which can be gripped by a user. The provision of such a handle will typically leave the first portion, i.e., the portion which extends substantially horizontally and at the top of the handle, free from being gripped by the main part of a user's hand. Instead, typically, a user's thumb may extend and rest at least partially on or towards the first portion. Accordingly, in a further set of embodiments the display is arranged on the first portion of the handle. The Applicant has recognized that by arranging the display on the first portion of the handle, for example on a top surface thereof, during typical use, the display will not be blocked by a user's hand and will thus remain free to be seen by a user as they operate the rotatable dial.

In addition or alternatively, in a set of embodiments the rotatable dial is arranged proximal to a corner where the first portion meets the second portion. Additionally, in embodiments where an input means is provided, preferably the input means is also provided proximal to a corner where the first portion meets the second portion. The Applicant has recognized that with an inverted ‘L’ shaped handle, as described above, arranging the rotatable dial (and the input means, when provided), at the corner between the first and second portions, this will typically be a region which is not covered by the main part of a user's hand and instead is a position which a user's thumb can easily reach. Accordingly, arranging the rotatable dial and input means in this manner may ensure that they are located in an easy to use position. In other embodiments the rotatable dial is arranged on the second portion, preferably at an upper end of the second portion.

The Applicant has recognized that the arrangement of the user interface on the handle, in accordance with the present invention, may improve the ease of use of various different types of liquid heating apparatus. However, in a preferred set of embodiments, the liquid heating apparatus is a kettle. The Applicant has recognized that users typically lift a kettle, using a handle provided thereon, in order to refill the kettle prior to each use and thus the provision of the user interface on the handle may improve the ease of use. The provision of the user interface on the handle of the apparatus may be beneficial for a corded apparatus. However, the Applicant has recognized that it is particularly advantageous for a cordless apparatus. Therefore, in a set of embodiments the liquid heating apparatus comprises a cordless vessel part comprising the liquid heating chamber, electrical heating arrangement and handle, and a power base on which the cordless vessel part is arranged to rest.

In at least some alternative arrangements, only the display of the user interface may be arranged on the handle while the rotatable dial is arranged on a body of the liquid heating apparatus. When viewed from a second aspect, the invention provides a domestic liquid heating apparatus, comprising: a liquid heating chamber defined by a body; an electrical heating arrangement arranged to heat, in use, a liquid contained in the liquid heating chamber; a handle, for lifting the apparatus; a rotatable dial, arranged on the body, and operable to select at least one operational parameter of the apparatus; and a display, arranged on the handle, to display the at least one operational parameter selected by the rotatable dial.

The Applicant has recognized that arranging the rotatable dial on the body of the liquid heating chamber can avoid inadvertent operation of the dial when a user grasps the handle to lift the apparatus. However, it is still convenient, and unusual, for the display to be arranged on the handle for ease of viewing.

In at least some embodiments, the rotatable dial is arranged on the body below the handle. This means that the display and the rotatable dial are in line with the handle and do not interfere with the walls of the body away from the handle, which may e.g., be transparent to allow a user to view the contents of the liquid heating chamber.

Various embodiments in accordance with this second aspect of the invention may include one or more of the features described hereinabove. In particular, the rotatable dial may further comprise or be associated with an input means (such as a push button) operable to implement the operational parameter selected by operation of the rotatable dial, as described above. In at least some embodiments, the rotatable dial is arranged to surround the input means and to rotate independently around the input means. In at least some embodiments, the rotatable dial and input means are provided by an integrated component. For example, the dial itself could also act as a push button. Any of the relevant features of the dial, input means and display described above may apply equally to such embodiments.

The display may take any suitable form, as already described above. In preferred embodiments, the display comprises an electronic display screen arranged on the handle.

In at least some alternative arrangements, a user interface comprising both the display and the rotatable dial may be arranged co-located on a body of the liquid heating apparatus rather than on the handle. When viewed from a third aspect, the invention provides a domestic liquid heating apparatus, comprising: a liquid heating chamber defined by a body; an electrical heating arrangement arranged to heat, in use, a liquid contained in the liquid heating chamber; a handle, for lifting the apparatus; a user interface comprising a rotatable dial, operable to select at least one operational parameter of the apparatus, and a display arranged to display the at least one operational parameter selected by the rotatable dial; wherein the user interface is arranged on the body with the rotatable dial co-located next to the display.

The Applicant has recognized that arranging the user interface on the body of the liquid heating chamber may be desirable to ensure that the user interface does not interfere with a user freely grasping the handle to lift the apparatus.

In at least some embodiments, the user interface is arranged on the body away from the handle. This means that the display and the rotatable dial may both face a user who is positioned to hold the handle.

In at least some embodiments, the user interface is arranged on the body below the handle. A user interface in line with the handle does not interfere with the walls of the body away from the handle, which may e.g., be transparent to allow a user to view the contents of the liquid heating chamber.

As for the second aspect, all relevant features mentioned in the context of the first aspect may be applied to the third aspect. In particular, the display may comprise an electronic display means. In some embodiments, the electronic display means may comprise a display screen co-located next to the rotatable dial. In some other embodiments, the electronic display means may comprise a series of light emitting means (e.g., LEDs) that are electronically controlled to indicate the at least one operational parameter selected by the rotatable dial. In some embodiments, the electronic display means may be co-located next to the rotatable dial so as to at least partially surround the rotatable dial. For example, the electronic display means may comprise a series of light emitting means (e.g., LEDs) that at least partially surround the rotatable dial. In at least some examples, the display comprises a plurality of light emitting means arranged along a scale representing a range of values of the at least one operational parameter, such as a temperature scale. As described above, a user may rotate the dial until an indicator thereon is aligned with an operational parameter (e.g., temperature) on the scale to be selected and then the associated light emitting means is electronically controlled to illuminate and thereby indicate the selection.

As also described above, the rotatable dial may be associated with an input means (such as a push button) operable to implement the operational parameter selected by operation of the rotatable dial. In some embodiments, the dial itself could also act as a push button. In some embodiments, the rotatable dial is arranged to surround the input means and to rotate independently around the input means. The input means may be arranged to be actuated along as axis of rotation of the rotatable dial.

Any of the relevant features of the dial, input means and display described above in relation to the first aspect may apply equally to embodiments of the third aspect.

Some features will now be described that are applicable to embodiments according to any of the aspects of the invention.

In a set of embodiments, the apparatus further comprises a dedicated power source arranged to provide power to the user interface. The addition of a dedicated power source for the user interface means that, particularly for a cordless liquid heating apparatus, the user interface can be operated whilst the cordless vessel part is lifted away from its associated power base. This is advantageous as it may, for example, allow a user to select an operational parameter using the rotatable dial whilst the cordless vessel part is being filled. Selecting the operational parameter at this point will remove the need for a user to select the operational parameter when the cordless vessel part is set back down, and thus may reduce the time and/or amount of input required following the setting down of the cordless apparatus once ready for use.

The liquid heating apparatus may comprise any suitable control arrangement for operating the apparatus, e.g., the electrical heating arrangement, in the manner selected by the rotatable dial (and input means, where provided). For example, the liquid heating apparatus may comprise analog control circuitry. Alternatively, or in addition, the apparatus may comprise an electronic processor arranged to operate the apparatus in the selected manner. The electronic processor may be arranged to control the electrical heating arrangement. The same electronic processor may optionally be arranged to control the display.

### BRIEF DESCRIPTION OF THE DRAWINGS

Some preferred embodiments of the present invention will now be described, by way of example only, and with reference to the accompanying drawings, in which:

FIG. 1 shows an isometric view of a domestic liquid heating apparatus in accordance with an embodiment of the present invention;

FIG. 2 shows a close-up view of the user interface provided on the apparatus seen in FIG. 1;

FIG. 3 shows a view from above of the user interface provided on the apparatus seen in FIG. 1;

FIG. 4 shows an isometric view of a domestic liquid heating apparatus in accordance with another embodiment of the present invention, in which a rotatable dial is arranged on the body of the apparatus and a display is located on the handle;

FIG. 5 shows an isometric view of a domestic liquid heating apparatus in accordance with another embodiment of the present invention, in which a rotatable dial is arranged on the body of the apparatus and a display is located on the handle;

FIG. 6 shows an isometric view of a domestic liquid heating apparatus in accordance with another embodiment of the present invention, in which the user interface is located on the body of the apparatus;

FIG. 7 shows the apparatus of FIG. 6 when the display next to the rotatable dial is illuminated; and

FIG. 8 shows the apparatus of FIG. 7 when a temperature has been selected by the user.

### DETAILED DESCRIPTION

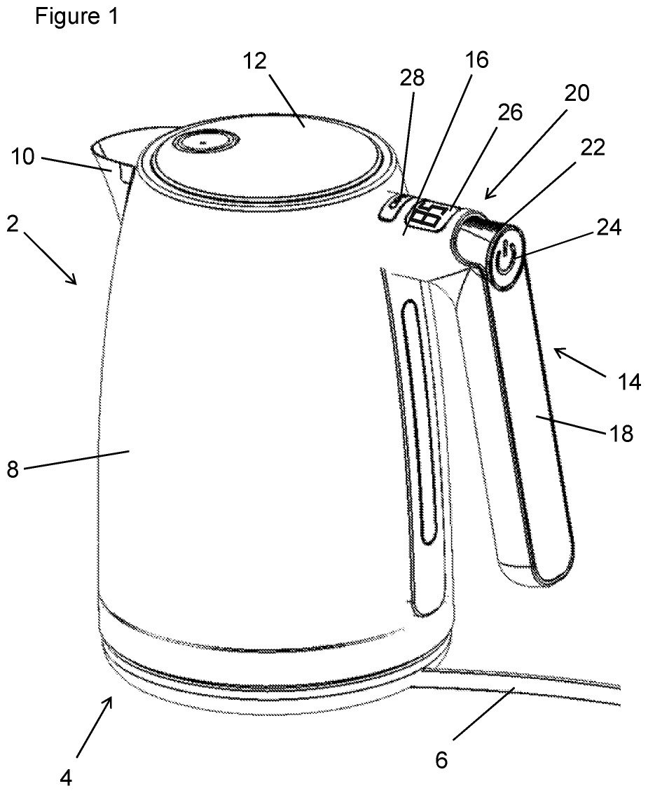

FIG. 1 shows an isometric view of a domestic liquid heating apparatus comprising a cordless kettle 2 resting on a power base 4. A power supply cord 6 extending from the power base 4 may, for example, be connected to a mains power supply and thus supply power to the apparatus. The kettle 2 comprises a cordless electrical connector (not shown) which cooperates with a corresponding cordless electrical connector (not shown) on the power base 4. Electrical power is supplied to the kettle 2 via the power supply cord 6 and cordless electrical connectors.

The kettle 2 comprises a liquid heating chamber 8 in which a liquid, e.g., water, may be heated in use. The liquid heating chamber 8 may be heated by any suitable heating means, for example an underfloor electrical heating arrangement comprising a sheathed heating element arranged in thermal communication with a base portion of the liquid heating chamber 8. Alternatively, an immersed electrical heating element may be provided in the liquid heating chamber 8. The kettle 2 further comprises a spout 10 through which a liquid may be dispensed from the liquid heating chamber 8. The top of the liquid heating chamber 8 is closed by a lid 12.

As can be seen in FIG. 1, the kettle 2 comprises a handle 14. The handle 14 generally has an inverted ‘L’ shape and comprises a first top portion 16 which extends substantially horizontally away from the heating chamber 8 and a second portion 18 which extends substantially vertically downwards towards a base of the kettle 2, forming a corner between the first portion 16, and the second portion 18.

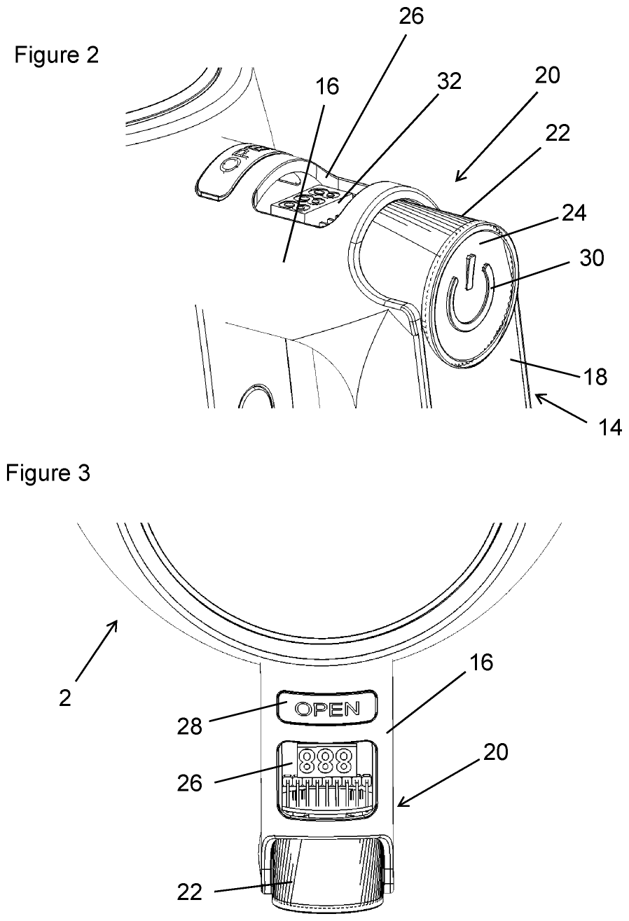

A user interface 20 is arranged on the handle 14 for controlling operation of the kettle 2. The user interface 20 comprises a rotatable dial 22, an optional input means in the form of a push button 24, and a display 26. In this particular embodiment, the display 26 comprises an LCD display with a cover arranged on top to form a display screen. The LCD display itself can be seen in FIGS. 2 and 3. In this particular embodiment, the rotatable dial 22 and push button 24 are provided as a single integrated component. In other words, the rotatable dial 22 and push button 24 are provided by a single component which can be rotated about its axis, to select at least one operational parameter of the kettle 2, e.g. the temperature to which the contents is heated, and also pushed along its axis to implement the selected operational parameter and/or to select least one further operational parameter of the kettle 2, e.g. to turn the kettle 2 ON/OFF, or to select a different heating mode.

Also provided on the first portion 16 of the handle 14 is an optional lid release button 28 for opening the lid 12 of the liquid heating chamber 8. As will be appreciated by those skilled in the art, the lid 12 may be released and opened in order to permit ease of refilling of the liquid heating chamber 8. Of course, the liquid heating chamber 8 may also be refilled directly through the spout 10 without opening the lid 12.

FIG. 2 shows a close-up view of the user interface 20. As can be seen more clearly in this Figure, the user interface 20 is integrated into the body of the handle 14. It is also apparent in this Figure how the integrated rotatable dial 22 and push button 24 are arranged in the handle 14 at the corner at which the first portion 16 and second portion 18 of the handle 14 meet. Accordingly, the rotatable dial 22 and push button 24 are arranged at a position on the handle 14 such that when a user grips the handle 14, the rotatable dial 22 and the push button 24 are not covered by the user's hand ensuring that they remain free to be operated. As can be seen, the push button 24 comprises a power symbol 30 provided by an at least partially transparent material extending through the body of the push button 24. Provided behind the push button 24 is a light source (not shown in this Figure) which illuminates the power symbol 30 when the kettle 2 is turned ON and thus provides an indication to the user that the kettle 2 is ON. The power symbol 30 provided on the push button 24 may also serve to indicate to a user the function of the push button 24.

Additionally, in FIG. 2, the cover on the display 26 has been removed to reveal the LCD display 32 which is arranged below. As is apparent, in this particular embodiment, the LCD display is configured to display numbers and thus may be used to display information such as temperature. However, as will be appreciated, any suitable display may be provided.

FIG. 3 shows a view from above of the kettle 2 and focusses on the user interface 20. As can be seen in this Figure, the lid release button 28 has the word “OPEN” marked thereon such that its function is clear to a user. Additionally, as is apparent from this Figure, the display 26 is located forward of the rotatable dial 22 such that, when a user is operating the rotatable dial 22, for example with a thumb, the display 26 is not obscured and thus a user can easily see the operational parameter being selected or adjusted.

Typical operation of the kettle 2 will now be described with reference to FIGS. 1 to 3. When a user wishes to use the kettle 2, assuming the kettle 2 is empty, they will first grasp the handle 14, lift the cordless kettle 2 away from the power base 4 and take the kettle 2 to a liquid source, for example a water tap, in order to fill the kettle 2. As will be appreciated by those skilled in the art, when a user grasps the handle 14, their fingers will naturally grip around the second portion 18 of the handle 14 and their thumb will typically extend towards and on to the top portion 16. With their thumb resting on the top portion 16 they can easily reach, and operate, the lid release button 28 whilst holding the kettle 2. Following operation of the lid release button 28, and thus opening of the lid 12, a user may then proceed to at least partially fill the liquid heating chamber 8.

Once the filling operation described above has been completed, a user may then proceed to replace the cordless kettle 2 on the power base 4. Once on the power base 4, a user, still with their fingers gripping the second portion 18 of the handle 14 and their thumb resting on the top portion 16, may proceed to operate the user interface 20 in order to select a desired setting and initiate a heating cycle. This may only be possible when the kettle 2 is placed on the power base 4 and thus the kettle 2 and user interface 20 is provided with power. A user may first operate the user interface 20 by rotating the rotatable dial 22 thereby selecting an operational parameter. As the dial is rotated, the output of the display 26 may change to reflect a change in the operational parameter being selected by the user. The displayed operational parameter in this particular embodiment may, for example, be the temperature to which the liquid contained within the liquid heating chamber 8 is to be heated.

Once the user has selected the desired operational parameter, the user may then press the push button 24 to implement the selected operational parameter, e.g., to turn the kettle 2 ON. Once the kettle 2 has been turned ON, the power symbol 30 may be illuminated to indicate to a user that the kettle 2 is ON. Additionally, whilst the kettle 2 is ON, the display 26 may output information in relation to the current state of the kettle 2, for example the current temperature of the liquid contained within the heating chamber 8. The kettle 2 may continue to operate, for example, until the liquid within the liquid heating chamber 8 has reached the desired temperature, and then subsequently switch off. Any suitable means for switching the kettle 2 OFF may be provided, as is well known in the art.

In an alternative set of embodiments, the cordless kettle 2 may comprise its own dedicated power supply for providing power to the user interface 20 when the kettle 2 is separated from the power base 4. In such a set of embodiments, a user may operate the user interface 20, for example by rotating the rotatable dial 22 and thus adjust the operational parameter, when the kettle 2 is separated from the power base 4, for example, whilst the kettle 2 is being filled.

In the particular embodiment shown in FIGS. 1 to 3, the handle 14 generally has the form of an inverted ‘L’ shape. However, as will be appreciated by those skilled in the art, this is not essential, and for example the handle 14 may take any suitable form which allows a user to lift the kettle 2. For example, the handle 14 may have a curved ‘C’ shape rather than an ‘L’ shape. For example, the handle 14 may comprise a further portion extending from the bottom of the second portion 18 back towards the liquid heating chamber 8 thus forming a ‘U’ shape.

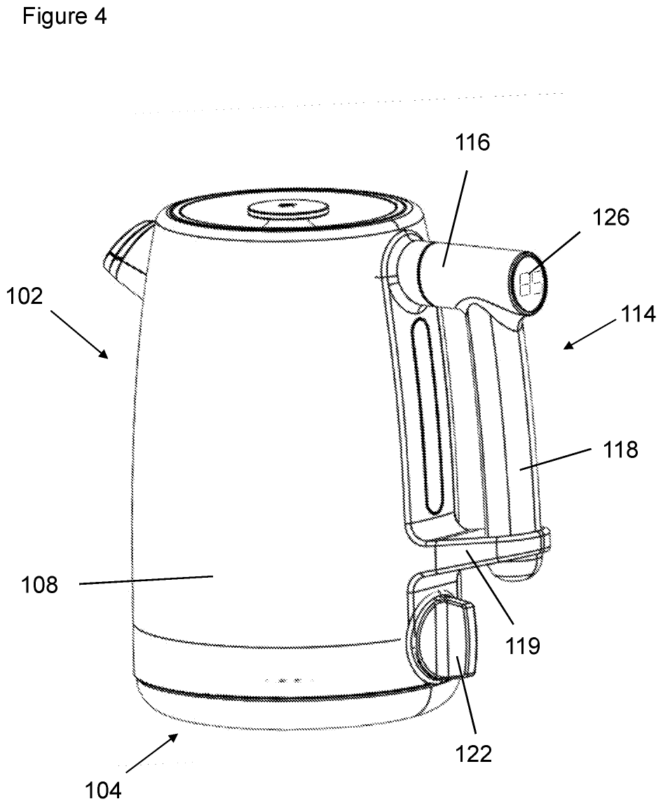

FIG. 4 shows an isometric view of a domestic liquid heating apparatus comprising a cordless kettle 102 resting on a power base 104, in accordance with a further embodiment of the claimed invention.

The kettle 102 comprises a liquid heating chamber 108 in which a liquid, e.g., water, may be heated in use. The liquid heating chamber 108 may be heated by any suitable heating means, for example an underfloor electrical heating arrangement comprising a sheathed heating element arranged in thermal communication with a base portion of the liquid heating chamber 108. Alternatively, an immersed electrical heating element may be provided in the liquid heating chamber 108.

The kettle 102 comprises a ‘C’ shaped handle 114. The handle 114 comprises a first top portion 116 which extends substantially horizontally away from the heating chamber 108 and a second portion 118 which extends substantially vertically downwards towards a base of the kettle 102, forming a corner between the first portion 116 and the second portion 118. The handle 114 further comprises a third portion 119 which extends substantially horizontally towards, and is adjoined to, the heating chamber 108, forming a corner between the second portion 118 and the third portion 119.

The top portion 116 of the handle 114 is substantially cylindrical and comprises a planar distal face, upon which a display screen 126 is arranged. The display screen 126 is configured to display an operational parameter, e.g., the temperature to which the contents of the kettle 102 is heated, as selected by the user.

A rotatable dial 122 is arranged on the outer surface of the heating chamber 108, below the third portion 119 of the handle 114, for controlling operation of the kettle 102. In this embodiment, the rotatable dial 122 takes the form of a push button. The rotatable dial 122 is a single component which can be rotated about its axis, to select at least one operational parameter of the kettle 102, e.g., the temperature to which the contents is heated, and also pushed along its axis to implement the selected operational parameter and/or to select least one further operational parameter of the kettle 102, e.g., to turn the kettle 102 ON/OFF. The display screen 126 is configured to display the operational parameter selected by the user through the rotation of the rotatable dial 122.

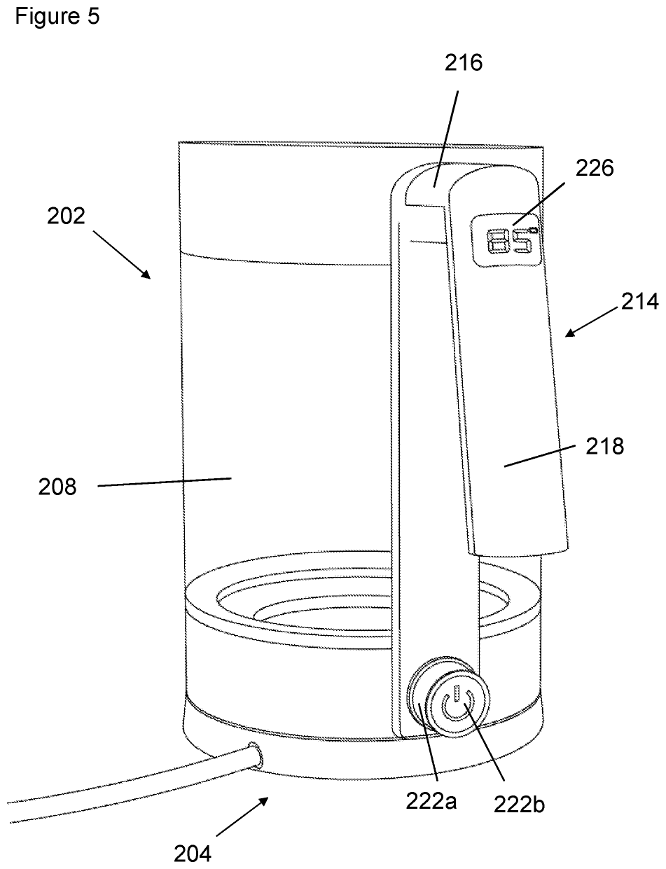

FIG. 5 shows an isometric view of a domestic liquid heating apparatus comprising a cordless kettle 202 resting on a power base 204, in accordance with a further embodiment of the claimed invention.

The kettle 202 comprises a liquid heating chamber 208 in which a liquid, e.g., water, may be heated in use. The liquid heating chamber 208 may be heated by any suitable heating means, for example an underfloor electrical heating arrangement comprising a sheathed heating element arranged in thermal communication with a base portion of the liquid heating chamber 208. Alternatively, an immersed electrical heating element may be provided in the liquid heating chamber 208. In this embodiment it can be seen that the liquid heating chamber 208 has transparent (e.g., glass) walls.

As can be seen in FIG. 5, the kettle 202 comprises a handle 214. The handle 214 generally has an inverted ‘L’ shape and comprises a first top portion 216, which extends substantially horizontally away from the heating chamber 208, and a second portion 218, which extends substantially vertically downwards towards a base of the kettle 202, forming a corner between the first portion 216 and the second portion 218.

A 226 is arranged on the surface of the second portion 218 of the handle 214. The display screen 226 is configured to display a parameter, e.g., the temperature to which the contents of the kettle 202 is heated, as selected by the user.

A rotatable dial 222a is arranged below the handle 218 for controlling operation of the kettle 202. The rotatable dial 222a surrounds input means in the form of a push button 222b. The rotatable dial 222a can be rotated about its axis, independently of the push button 222b, to select at least one operational parameter of the kettle 202, e.g., the temperature to which the contents are heated. The push button 222b can independently be pushed along its axis to implement the selected operational parameter and/or to select least one further operational parameter of the kettle 202, e.g., to turn the kettle 202 ON/OFF, or to select a different heating mode. The display screen 226 is configured to display the operational parameter selected by the user.

Arranging the rotatable dial 122, 222a on the body of the liquid heating chamber 108, 208 in the manner discussed above, with reference to FIGS. 4 and 5, means that inadvertent operation of the dial 122, 222a when a user grasps the handle 114, 214 to lift the apparatus can be avoided. However, the display 126, 226 is conveniently arranged on the handle 114, 214 for ease of viewing.

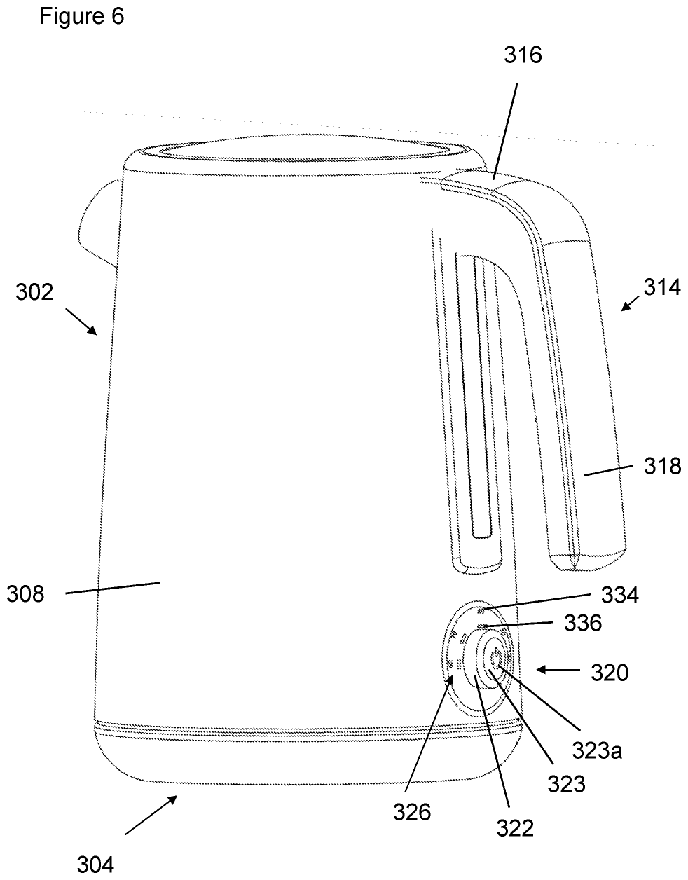

FIG. 6 shows an isometric view of a domestic liquid heating apparatus comprising a cordless kettle 302 resting on a power base 304, in accordance with a further embodiment of the claimed invention.

The kettle 302 comprises a liquid heating chamber 308 in which a liquid, e.g., water, may be heated in use. The liquid heating chamber 308 may be heated by any suitable heating means, for example an underfloor electrical heating arrangement comprising a sheathed heating element arranged in thermal communication with a base portion of the liquid heating chamber 308. Alternatively, an immersed electrical heating element may be provided in the liquid heating chamber 308.

As can be seen in FIG. 6, the kettle 302 comprises a handle 314. The handle 314 generally has an inverted shape and comprises a first top portion 316 which extends substantially horizontally away from the heating chamber 308 and a second portion 318 which extends substantially vertically downwards towards a base of the kettle 302, forming a corner between the first portion 316, and the second portion 318.

A user interface 320, comprising a rotatable dial 322 and a circular display 326, is arranged on the outer surface of the heating chamber 308 for controlling operation of the kettle 302. The rotatable dial 322 surrounds input means in the form of a push button 323. The rotatable dial 322 can be rotated about its axis, to select at least one operational parameter of the kettle 302, e.g., the temperature to which the contents is heated. In some examples, the rotatable dial 322 and push button 323 may be integrated as a single rotatable component that is pushed along its axis to implement the selected operational parameter and/or to select least one further operational parameter of the kettle 302, e.g., to turn the kettle 302 ON/OFF. In other examples, the rotatable dial 322 and push button 323 may be independently operable components, rotatable dial 322 rotating independently around the push button 323 and the push button 323 being pushed independently to implement the selected operational parameter, e.g., to turn the kettle 302 ON/OFF.

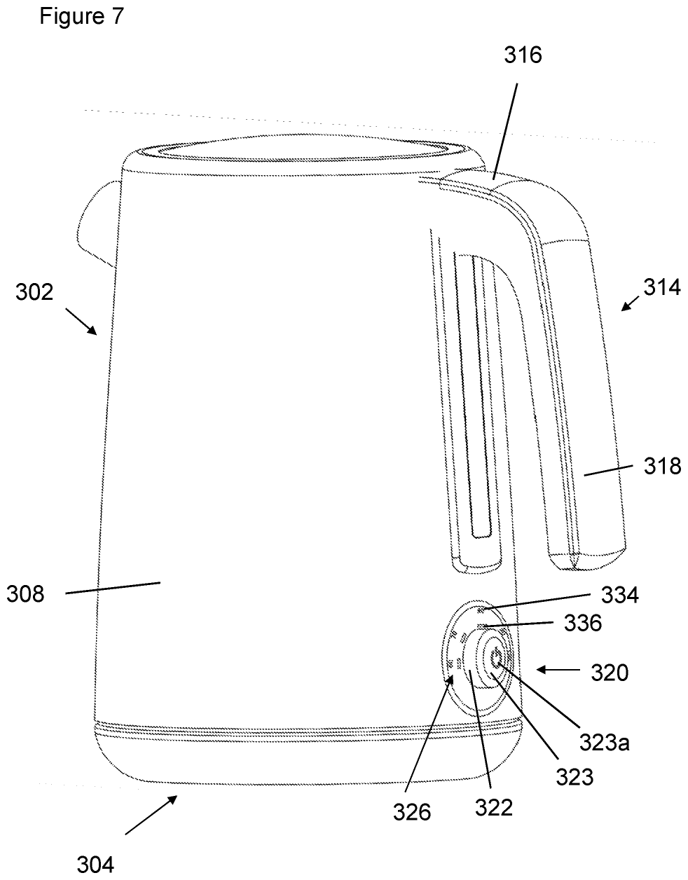

The push button 323 further comprises its own further LED display 323a that is configured to illuminate when the operational parameter is selected, e.g., to indicate that the kettle 302 is ON. FIG. 7 shows the LED display 323a of FIG. 6 in its illuminated state.

The circular display 326 is arranged on the outer surface of the heating chamber 308 such that the rotatable dial 322 is concentrically co-located next to the circular display 326, i.e., the center point of the circular display 326 is arranged on the axis of rotation of the rotatable dial 322. The display 326 comprises a plurality of circumferentially spaced labels 334, wherein each label 334 indicates a position of the rotatable dial 322 that corresponds to a different value of the operational parameter to be selected by the user. In this example, each label 334 shows a different temperature value. The display 326 further comprises a plurality of circumferentially spaced LEDs 336, positioned adjacent each of the labels 334. Each LED 336 is configured to illuminate when the rotatable dial 322 is rotated such that the value of the operational parameter that corresponds to the label 334 adjacent the LED 336 is selected.

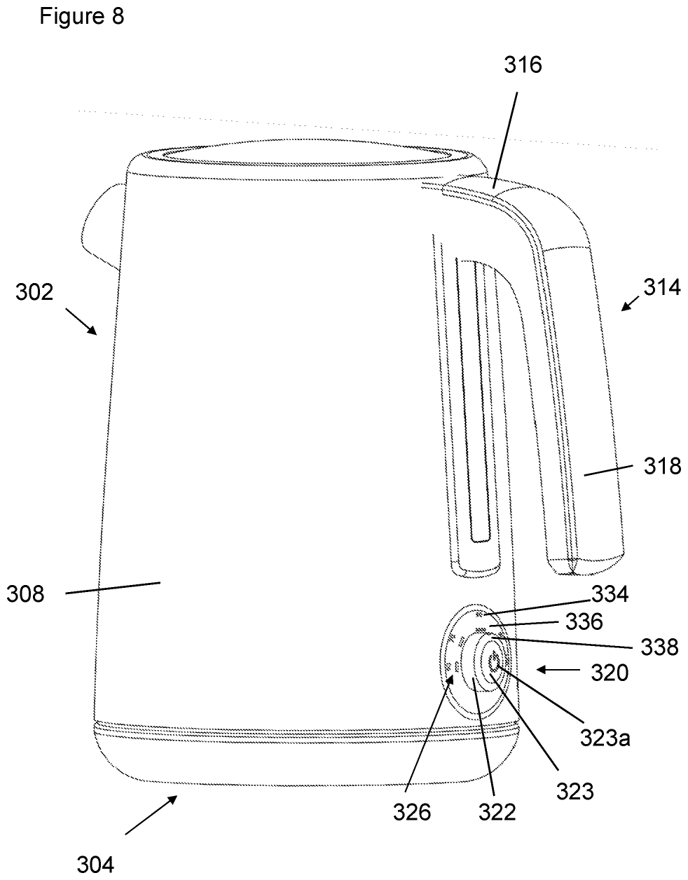

FIG. 8 shows the device of FIGS. 6 and 7 when a temperature of 80° has been selected by the rotation of the rotatable dial 322. Thus, in this state, the corresponding LED 336 is illuminated. The rotatable dial 322 comprises a marker 338 (shown in FIG. 8), e.g., an indent, positioned at a point on the circumference of the rotatable dial 322, such that it is adjacent the label 334 that corresponds to the current selection of the operational parameter.

Thus, in operation, in order to select a desired value of the operational parameter, the user rotates the rotatable dial 322 such that the marker 338 aligns with the label 334 that corresponds to the desired value. When the marker 338 is aligned with this label 334, the LED 336 adjacent the label 334 is configured to illuminate, thereby informing the user that the desired selection has been made. In order to implement the selected operational parameter and/or to select least one further operational parameter of the kettle 302, e.g., to turn the kettle 302 ON/OFF, the user pushes the button 323 along its axis.

Arranging the user interface 320 on the body of the liquid heating chamber 308 in the manner discussed above, with reference to FIGS. 6 to 8, means that the user interface 320 does not interfere with a user freely grasping the handle 314 to lift the apparatus.

While the invention has been described with reference to exemplary embodiments and applications scenarios, it will be understood by those skilled in the art that various changes may be made and equivalents may be substituted for elements thereof without departing from the scope of the claims. Therefore, it is intended that the invention not be limited to the particular embodiments disclosed, but that the invention will include all embodiments falling within the scope of the appended claims and can be applied to various application in the industrial as well as commercial field.

What is claimed is:

1. A domestic liquid heating apparatus, comprising:
a liquid heating chamber and an electrical heating arrangement arranged to heat, in use, a liquid contained in the liquid heating chamber;
a handle, for lifting the apparatus; and
a user interface, arranged on the handle, comprising:
a rotatable dial operable to select at least one operational parameter of the apparatus; and
a display arranged to display the at least one operational parameter selected by operation of the rotatable dial.

2. The domestic liquid heating apparatus as claimed in claim 1 wherein the at least one operational parameter corresponds to a final temperature to which the electrical heating arrangement is arranged to heat the liquid contained in the liquid heating chamber.

3. The domestic liquid heating apparatus as claimed in claim 1 wherein the user interface further comprises an input means operable to implement the operational parameter selected by operation of the rotatable dial.

4. The domestic liquid heating apparatus as claimed claim 3 wherein the input means is operable to select or control at least one further operational parameter.

5. The domestic liquid heating apparatus as claimed in claim 4 wherein the at least one further operational parameter corresponds to a pre-set mode of operation.

6. The domestic liquid heating apparatus as claimed in claim 4 wherein the at least one further operational parameter selected by the input means is also displayed on the display.

7. The domestic liquid heating apparatus as claimed in claim 3 wherein the input means is operable to change the at least one operational parameter which the rotatable dial is arranged to select.

8. The domestic liquid heating apparatus as claimed in claim 3 wherein the input means comprises a further display.

9. The domestic liquid heating apparatus as claimed in claim 3 wherein the input means comprises a push button.

10. The domestic liquid heating apparatus as claimed in claim 9 wherein the push button is arranged to implement the selected operational parameter and/or select at least one further operational parameter based on a number of pushes of the push button.

11. The domestic liquid heating apparatus as claimed in claim 9 wherein the push button is arranged to implement the selected operational parameter and/or select at least one further operational parameter based on a time for which the push button is depressed by a user.

12. The domestic liquid heating apparatus as claimed in claim 3 wherein the rotatable dial and input means are provided by separate, independently operable components such that the rotatable dial is arranged to rotate relative to the input means.

13. The domestic liquid heating apparatus as claimed in claim 12 wherein the rotatable dial is arranged to surround the input means and is arranged to rotate independently around the input means.

14. The domestic liquid heating apparatus as claimed in claim 12 wherein the input means is arranged to be actuated along an axis of rotation of the rotatable dial.

15. The domestic liquid heating apparatus as claimed in claim 3 wherein the rotatable dial and input means are provided by an integrated component arranged to rotate to control the at least one operational parameter and depress/push to implement the selected operational parameter and/or select at least one further operational parameter.

16. The domestic liquid heating apparatus as claimed in claim 15 wherein the integrated component is provided by a knob which can both rotate and be depressed along its axis of rotation.

17. The domestic liquid heating apparatus as claimed in claim 1 wherein the display comprises an electronic display means.

18-21. (canceled)

22. The domestic liquid heating apparatus as claimed in claim 1 wherein the user interface is arranged on an upper portion of the handle.

23-29. (canceled)

30. A domestic liquid heating apparatus, comprising:
a liquid heating chamber defined by a body;
an electrical heating arrangement arranged to heat, in use, a liquid contained in the liquid heating chamber;
a handle, for lifting the apparatus; and
a user interface comprising:
a rotatable dial, arranged on the body, and operable to select at least one operational parameter of the apparatus; and
a display, arranged on the handle, to display the at least one operational parameter selected by the rotatable dial.

31-53. (canceled)

54. A domestic liquid heating apparatus, comprising:
a liquid heating chamber defined by a body;
an electrical heating arrangement arranged to heat, in use, a liquid contained in the liquid heating chamber;
a handle, for lifting the apparatus;
a user interface comprising a rotatable dial, operable to select at least one operational parameter of the apparatus, and a display arranged to display the at least one operational parameter selected by the rotatable dial;
wherein the user interface is arranged on the body with the rotatable dial co-located next to the display.

55-79. (canceled)
